(19) United States
(12) Patent Application Publication
(10) Pub. No.: US 2019/0174804 A1
(43) Pub. Date: Jun. 13, 2019

(54) METHOD OF MANUFACTURING INSTANT PORRIDGE

(71) Applicant: Sea World CO., LTD., Sokcho-si (KR)

(72) Inventor: Hak-Do Lee, Sokcho-si (KR)

(73) Assignee: Sea World CO., LTD., Sokcho-si (KR)

(21) Appl. No.: 15/841,316

(22) Filed: Dec. 14, 2017

(30) Foreign Application Priority Data
Dec. 12, 2017 (KR) 10-2017-0170425

(51) Int. Cl. A23L 7/143; A23L 5/10; A23L 17/00; A23L 19/00

(52) U.S. Cl. CPC A23L 7/143; A23L 5/10; A23V 2002/00; A23L 19/00; A23L 17/00

(57) ABSTRACT

A method of manufacturing instant porridge includes manufacturing stock by mixing and heating 1,000 parts by weight of water with 500 to 600 parts by weight of kelp, 100 to 150 parts by weight of white radishes, 120 to 130 parts by weight of onions, and 80 to 90 parts by weight of scallions for 60 to 70 minutes, manufacturing a stock mixture, manufacturing a porridge material by mixing and heating the stock mixture with main ingredients for 20 to 25 minutes, freeze-drying the porridge material for 70 to 80 hours, obtaining porridge material flakes by processing the freeze-dried porridge material, manufacturing rice porridge using mixed rice obtained by mixing glutinous rice with nonglutinous rice, and packing each of the porridge material flakes and the rice porridge.

### CROSS-REFERENCE TO RELATED APPLICATION

This application claims priority to and the benefit of Korean Patent Application No. 2017-0170425, filed on Dec. 12, 2017, the disclosure of which is incorporated herein by reference in its entirety.

### BACKGROUND

### 1. Field of the Invention

The present invention relates to a method of manufacturing instant porridge, and more particularly, to a method of manufacturing instant porridge with excellent convenience and conservative property.

### 2. Discussion of Related Art

Recently, according to changes and developments in dietary life, dietary habits have mostly tended towards a preference for convenient food, and thus a large amount of convenient food has been processed. Accordingly, with respect to porridge, which is a traditional Korean food, ready-to-eat products, which are convenient and capable of being put in a container and warmed up in a microwave oven, have been developed and marketed.

Porridge is a liquid food made by adding a large amount of water to grain such as rice, barley, millet, and the like and boiling them for a long time such that the grains are broken down and become soft to allow starch to be completely gelatinized. A main ingredient of porridge is grain, but porridge gains flavor by other food ingredients being added thereto and includes a variety of functions according to types of the ingredients to be used as a therapeutic diet, a health food, an extraordinarily tasty food, a food for seniors, a weaning food, and the like.

Above all, porridge may be referred to as a representative traditional food which has emotional meaning for Koreans. It is known that there are about 120 or more types of traditional rice-based porridge according to ingredients added thereto. Porridge, generally used as staple food with boiled rice in dietary lives of Koreans, has been gradually increasingly consumed as a convenient diet breakfast food of a busy worker due to calories thereof, which is 30 to 50 kcal per 100 g.

Due to the above advantage, the consumption of porridge has increased. However, generally, there is a limitation in that a method of manufacturing porridge consumes a large amount of time.

### PRIOR ART DOCUMENT

### Patent Document

Korean Patent Registration Publication No. 10-1311560 (Sep. 16, 2013)

### SUMMARY OF THE INVENTION

Therefore, it is an aspect of the present invention to provide a method of manufacturing instant porridge capable of simply manufacturing porridge in a short time.

According to one aspect of the present invention, a method of manufacturing instant porridge includes manufacturing stock by mixing and heating 1,000 parts by weight of water with 500 to 600 parts by weight of kelp, 100 to 150 parts by weight of white radishes, 120 to 130 parts by weight of onions, and 80 to 90 parts by weight of scallions for 60 to 70 minutes, manufacturing a stock mixture by mixing the stock with 5 to 6 parts by weight of shrimp, 7 to 8 parts by weight of oysters, 7 to 8 parts by weight of squid, 7 to 8 parts by weight of mussels, 30 to 40 parts by weight of chives, 0.01 to 0.015 parts by weight of salt, and 3 to 4 parts by weight of sesame oil, and heating the mixture for 10 to 15 minutes, manufacturing a porridge material by mixing and heating the stock mixture with main ingredients for 20 to 25 minutes, freeze-drying the porridge material for 70 to 80 hours, obtaining porridge material flakes by processing the freeze-dried porridge material, manufacturing rice porridge using mixed rice obtained by mixing glutinous rice with nonglutinous rice, and packing each of the porridge material flakes and the rice porridge.

The manufacturing of the rice porridge may include mixing 160 to 180 parts by weight of the mixed rice obtained by mixing glutinous rice with nonglutinous rice with 230 to 250 parts by weight of water and soaking the mixed rice in the water at a temperature of 10 to 25° C. for 20 to 30 minutes, and heating and cooking the soaked mixed rice and the water for 20 to 25 minutes.

The main ingredients may include abalone meat and viscera.

The main ingredients may include octopus and kimchi.

The main ingredients may include seaweed fulvescens and oysters.

The main ingredients may include beef, carrots, cabbage, and broccoli.

### DETAILED DESCRIPTION OF EXEMPLARY EMBODIMENTS

Since the present invention may be variously modified and may have several forms, embodiments will be described herein in detail. However, it should be understood that the present invention is not limited to the particular embodiments, and includes all modifications, equivalents, and substitutes included in the concept and technical scope of the present invention. In a description referencing the drawings, like reference numerals refer to like elements. Although terms such as first, second, and the like may be used to describe various elements, the elements are not limited by the terms.

The terms are used only for distinguishing one element from other elements. The terms used herein are used only to describe the particular embodiments and are not intended to limit the present invention. Singular forms, unless defined otherwise in context, include plural forms.

Throughout the application, it should be understood that the terms “comprise,” “include,” and the like are used herein to specify the presence of stated features, numbers, steps, operations, elements, components, or combinations thereof but do not preclude the presence or addition of one or more other features, numbers, steps, operations, elements, components, or combinations thereof.

Unless otherwise defined, all terms used herein including technical or scientific terms have the same meanings as those generally understood by one of ordinary skill in the art. Terms such as those defined in generally used dictionaries should be understood as having meanings identical to meanings contextually defined in the art, and are not to be understood in an exaggerated or excessively formal sense unless expressly defined herein.

Hereinafter, exemplary examples of a method of manufacturing instant porridge according to one embodiment of the present invention will be described in detail.

The method of manufacturing instant porridge according to one embodiment of the present invention increases a conservative property of a finished product by mixing and manufacturing a stock mixture with main ingredients of porridge as flakes, and, for this, includes manufacturing stock, manufacturing a stock mixture by mixing the stock with a variety of condiments, manufacturing a porridge material by mixing the stock mixture with main ingredients of porridge, freeze-drying the porridge material, and obtaining flakes by processing the freeze-dried porridge material.

First, the operation of manufacturing stock includes a process of washing kelp, white radishes, onions, and scallions, which are stock materials. When the stock materials have been washed, 1,000 parts by weight of water are mixed with 500 to 600 parts by weight of kelp, 100 to 150 parts by weight of white radishes, 120 to 130 parts by weight of onions, and 80 to 90 parts by weight of scallions, and the mixture is heated for 60 to 70 minutes. The stock is manufactured through this process.

When the stock is manufactured, a stock mixture is manufactured by mixing the stock with a variety of condiments. For example, condiments to be mixed with the stock may include shrimp, oysters, squid, mussels, chives, salt, and sesame oil. Preferably, 5 to 6 parts by weight of shrimp, 7 to 8 parts by weight of oysters, 7 to 8 parts by weight of squid, 7 to 8 parts by weight of mussels, 30 to 40 parts by weight of chives, 0.01 to 0.015 parts by weight of salt, and 3 to 4 parts by weight of sesame oil may be mixed with the stock. After the stock is mixed with the variety of condiments and heated for 10 to 15 minutes, the stock mixture is manufactured.

When the stock mixture is manufactured, the main ingredients of porridge are mixed with the stock mixture. There are many kinds of porridge, and the kind of porridge may vary according to the main ingredients. For example, abalone porridge, seafood porridge, octopus and kimchi porridge, seaweed fulvescens and oyster porridge, beef and vegetable porridge, and the like exist. When the main ingredients are a material of abalone porridge, the main ingredients may include abalone meat and viscera. When the main ingredients are a material of octopus and kimchi porridge, the main ingredients may include octopus and kimchi. When the main ingredients are a material of seaweed fulvescens and oyster porridge, the main ingredients may include seaweed fulvescens and oysters. When the main ingredients are a material of beef and vegetable porridge, the main ingredients may include beef, carrots, cabbage, and broccoli.

The main ingredients of porridge are mixed with the stock mixture and then heated for 20 to 25 minutes to manufacture a porridge material. The manufactured porridge material goes through a freeze-drying process for 70 to 80 hours, and the freeze-dried porridge material is processed such that porridge material flakes may be obtained therefrom. 35 g of the porridge material flakes may be packed for one portion, and the porridge material flakes may go through a sterilization process to be packed (nitrogen gas packing) in a sealed state.

When the porridge material flakes are completed, rice porridge is manufactured. The rice porridge is manufactured using mixed rice obtained by mixing glutinous rice with nonglutinous rice. An operation of manufacturing rice porridge may include mixing 160 to 180 parts by weight of mixed rice, which is obtained by mixing glutinous rice with nonglutinous rice, with 230 to 250 parts by weight of water, soaking the mixed rice in water at a temperature of 10 to 25° C. for 20 to 30 minutes, and heating and cooking the soaked mixed rice and the water for 20 to 25 minutes. 300 g of the completed rice porridge may be packed for one portion, and the rice porridge may go through a sterilization process to be packed in a sealed state.

A method of preparing instant porridge using packed flakes and rice porridge may include opening and mixing the packed flakes and rice porridge, and mixing and heating the mixed flakes and rice porridge with water using a stove for 3 to 4 minutes or a microwave oven for 4 to 5 minutes. Accordingly, it is possible to simply and quickly prepare porridge using the packed flakes and rice porridge.

According to the embodiment of the present invention, porridge ingredient flakes are separately packed using a stock mixture and main ingredients of porridge, and rice porridge is manufactured and separately packed. Accordingly, since it is only necessary to mix the porridge ingredient flakes with the rice porridge, porridge may easily and quickly prepared.

Although the embodiments of the present disclosure have been described above, it should be appreciated by one of ordinary skill in the art that a variety of changes and modifications may be made in these embodiments without departing from the concept and scope of the present invention defined in the following claims.

What is claimed is:

1. A method of manufacturing instant porridge, comprising:
manufacturing stock by mixing and heating 1,000 parts by weight of water with 500 to 600 parts by weight of kelp, 100 to 150 parts by weight of white radishes, 120 to 130 parts by weight of onions, and 80 to 90 parts by weight of scallions for 60 to 70 minutes;
manufacturing a stock mixture by mixing the stock with 5 to 6 parts by weight of shrimp, 7 to 8 parts by weight of oysters, 7 to 8 parts by weight of squid, 7 to 8 parts by weight of mussels, 30 to 40 parts by weight of chives, 0.01 to 0.015 parts by weight of salt, and 3 to 4 parts by weight of sesame oil, and heating the mixture for 10 to 15 minutes;
manufacturing a porridge material by mixing and heating the stock mixture with main ingredients for 20 to 25 minutes;
freeze-drying the porridge material for 70 to 80 hours;
obtaining porridge material flakes by processing the freeze-dried porridge material;
manufacturing rice porridge using mixed rice obtained by mixing glutinous rice with nonglutinous rice; and
packing each of the porridge material flakes and the rice porridge.

2. The method of claim 1, wherein the manufacturing of rice porridge comprises:
mixing 160 to 180 parts by weight of the mixed rice obtained by mixing glutinous rice with nonglutinous rice with 230 to 250 parts by weight of water and soaking the mixed rice in the water at a temperature of 10 to 25° C. for 20 to 30 minutes; and
heating and cooking the soaked mixed rice and the water for 20 to 25 minutes.

3. The method of claim 1, wherein the main ingredients comprise abalone meat and viscera.

4. The method of claim 1, wherein the main ingredients comprise octopus and kimchi.

5. The method of claim 1, wherein the main ingredients comprise seaweed fulvescens and oysters.

6. The method of claim 1, wherein the main ingredients comprise beef, carrots, cabbage, and broccoli.
